(19) United States
(12) Patent Application Publication
(10) Pub. No.: US 2025/0322465 A1
(43) Pub. Date: Oct. 16, 2025

(54) TAX ADVICE, TAX PREPARATION AND OTHER SERVICES

(71) Applicant: Tax and Relax, Inc., Ozone Park, NY (US)

(72) Inventor: Deanna Blandino, Ozone Park, NY (US)

(21) Appl. No.: 19/175,641

(22) Filed: Apr. 10, 2025

Related U.S. Application Data
(60) Provisional application No. 63/632,219, filed on Apr. 10, 2024.

(51) Int. Cl. G06Q 40/12

(52) U.S. Cl. CPC G06Q 40/123

(57) ABSTRACT

A mobile tax service whereby a tax professional travels to an individual's home, place of business, or other desired location to speak with the individual, review tax related documents, provide tax related advice, and, if needed, assist in the preparation of the individual's tax returns remotely.

### CROSS-REFERENCE TO RELATED APPLICATION

This patent application claims benefit to U.S. Provisional Patent Application No. 63/632,219, filed Apr. 10, 2024, which is hereby incorporated by reference in its entirety as part of the present disclosure.

### FIELD OF THE INVENTION

The present disclosure generally relates generally to tax advice for individuals and businesses, tax preparation for individuals and businesses, bookkeeping services, payroll assistance and processing and other services, and more specifically to a mobile service offering tax advice, tax preparation services, bookkeeping services, payroll assistance and other services directed, for example, to relaxation, wellness and healing.

### BACKGROUND OF THE INVENTION

Commonly, the review of tax related documents for individuals and businesses, preparation of tax returns for individuals and businesses, the filing of tax returns for individuals and businesses, bookkeeping services and payroll related matters is done by a tax professional, such as an accountant. These processes occur regularly occurs at the office of the tax professional. Similarly, services relating to relaxation, wellness and healing typically can be found at brick-and-mortar facilities. While it may be conducive for certain individuals to travel to a place of business to address tax related matters, and other services relating to relaxation, wellness and healing may be acceptable for certain individual's, it is not possible and/or desirable for others to be able to go to the office of a tax advisor, accountant, etc. This can be because the individual is not physically able to travel and/or has significant mobility issues, does not have childcare, holds a job with hours that does not allow for the individual to visit a tax professional's office, has severe anxiety and/stress about their taxes and cannot bring themselves to go to a tax professional's office, etc. Not only can this be detrimental to the proper advice, preparation and filing of the individual's tax returns, but it can lead to stress and anxiety.

### SUMMARY OF THE INVENTION

The present disclosure is directed to a mobile tax service. The tax service can include a tax professional(s) (e.g., accountant) that travel(s) to an individual(s) home, place of business, or other desired location to speak with the individual(s), review tax related documents, provide tax related advice, and, if needed, assist in the preparation of the individual(s) and/or their business' tax return(s) remotely. Thus, avoiding the need for the individual(s) to have to travel to the tax professional's place of business. The service allows for both convenance and efficiency. The service additional can assist with bookkeeping and payroll.

In an embodiment, the mobile service can include a tax professional traveling to an individual's home, a place of business or other place of the individual's choosing to review personal and/or business tax related documents with the individual, take the tax related materials back to the tax professional's place of business and then returning the documents to the individual so that the individual does not have to travel to the tax professional's place of business. The service is designed to convenience the individual.

In another embodiment the mobile service can include, for example, a vehicle (e.g., a van) or attachment thereto (e.g. mobile trailer) that is outfitted with all necessary devices and supplies (e.g., computers, printers, scanners, phones, office supplies, etc.) that would be commonly found at the place of business of a tax professional. The tax professional could perform all necessary tasks related to tax matters, bookkeeping, and payroll in the vehicle. This would allow for a face-to-face meeting without the need for the individual to travel to the tax professional's office.

In addition to tax preparation, bookkeeping and payroll, the service can include other services directed, for example, to relaxation, wellness and healing. These services would be tangential to the tax, bookkeeping and payroll services.

Commonly, individual's that travel to the place of business of a tax preparer can reach high levels of stress and/or anxiety over the amount money they may owe to the state and/or federal government. This can lead to the individual not focused on their taxes and possibly forgetful of key facts the tax professional should know as they review tax related documents, bookkeeping matters, and/or payroll. It could also lead to personal physical and/or mental conditions.

To aid such individuals deal with their stress, anxiety, etc., in an embodiment, massage services could be offered as part of the tax service with the intent to relax the individual prior to and/or while they are speaking with a tax professional. In additional and/or alternatively, other services that could lead to relaxation such as manicures', pedicures, facials, iv drips, etc. can be offered to individuals. Such services should not be limited to those disclosed herein.

In an embodiment, the services references above could be offered in a vehicle (e.g., van) or attachment thereto (e.g. mobile trailer) along with the tax related services. For example, the tax professional could arrive at an individual's home in a vehicle equipped with facilities and supplies to review and complete tax related matters and a massage table or massage chair or other health and wellness services, drinks, etc. Alternatively, the tax preparer could arrive with an enclosed trailer attached to a vehicle with all of the above included therein.

As an alternative, or in addition to providing mobile services, the tax preparer could provide consultation services and wellness services in view of the above remotely then return to their place of business for further analysis of tax related documents and/or to prepare tax returns, assess payroll and/or bookkeeping maters and then return the individual's remote location (e.g., their home) to review the analysis, tax return, etc. with the individual prior to filing tax returns, processing payroll or addressing bookkeeping matters, if desired.

### BRIEF DESCRIPTION OF THE DRAWINGS

FIG. 1 is a flowchart of an embodiment of mobile tax services according to an embodiment of the present disclosure;

FIG. 2A is a schematic of an embodiment of a mobile tax vehicle according to an embodiment of the present disclosure;

FIG. 2B is a schematic of an embodiment of a mobile tax vehicle with an attached trailer according to an embodiment of the present disclosure; and

FIG. 3 is a schematic of an embodiment of a mobile tax vehicle with added features such as wellness and consultation services according to an embodiment of the present disclosure;

### DETAILED DESCRIPTION OF EMBODIMENTS OF THE PRESENT DISCLOSURE

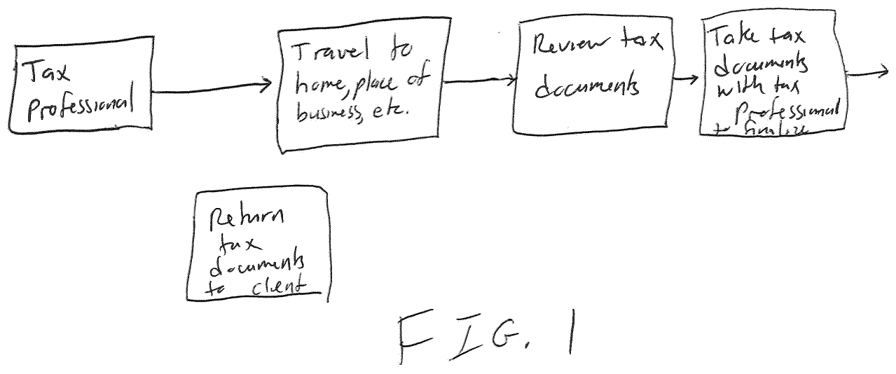

With reference now to the figures and in particular FIGS. 1-3 embodiments of the mobile tax and related services of the present disclosure will be described.

The present disclosure is directed to a mobile tax service as outlined in FIG. 1. The tax service can include a tax professional(s) (e.g., accountant) that travel(s) to an individual(s) home, place of business, or other desired location to speak with the individual(s), review tax related documents, provide tax related advice, and, if needed, assist in the preparation of the individual(s) and/or their business' tax return(s) remotely. Thus, avoiding the need for the individual(s) to have to travel to the tax professional's place of business. The service allows for both convenance and efficiency. The service additional can assist with bookkeeping and payroll.

In an embodiment, the mobile service can include a tax professional traveling to an individual's home, a place of business or other place of the individual's choosing to review personal and/or business tax related documents with the individual, take the tax related materials back to the tax professional's place of business and then returning the documents to the individual so that the individual does not have to travel to the tax professional's place of business. The service is designed to convenience the individual.

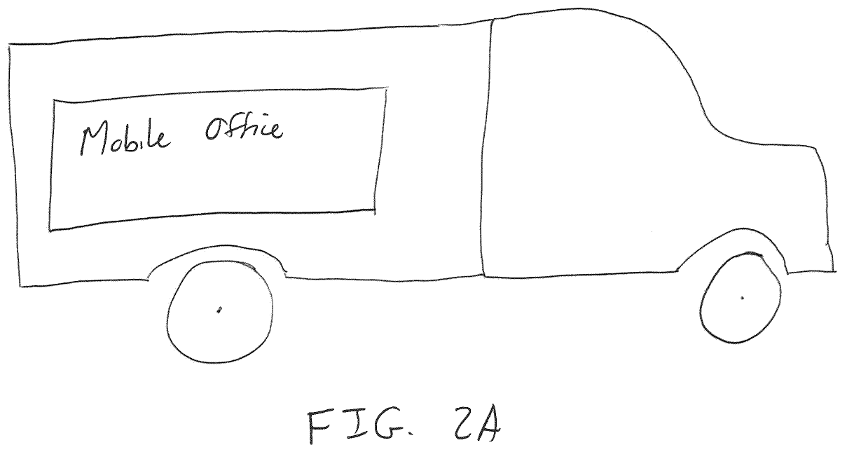

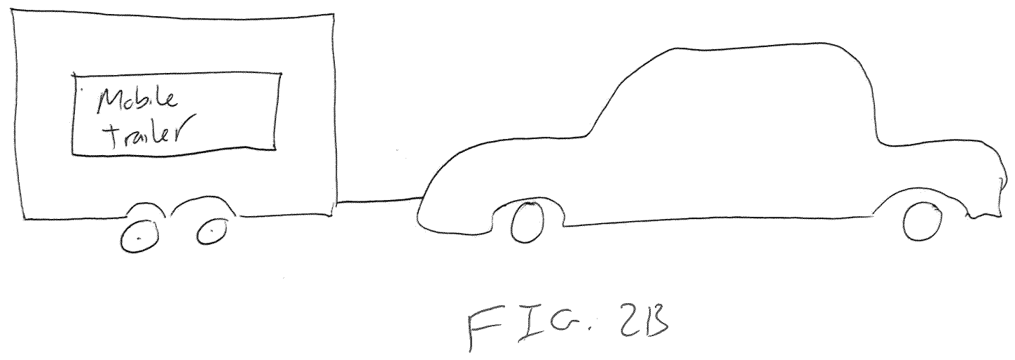

In another embodiment, as shown in FIGS. 2A and 2B, the mobile service can include, for example, a vehicle (e.g., a van) or attachment thereto (e.g. mobile trailer) that is outfitted with all necessary devices and supplies (e.g., computers, printers, scanners, phones, office supplies, etc.) that would be commonly found at the place of business of a tax professional. The tax professional could perform all necessary tasks related to tax matters, bookkeeping, and payroll in the vehicle. This would allow for a face-to-face meeting without the need for the individual to travel to the tax professional's office.

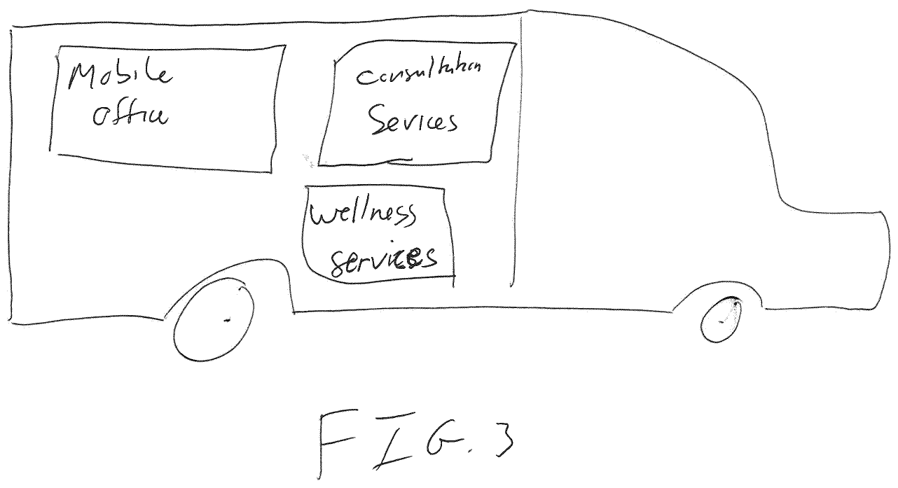

In addition to tax preparation, bookkeeping and payroll, as shown in FIG. 3, the service can include other services directed, for example, to relaxation, wellness and healing. These services would be tangential to the tax, bookkeeping and payroll services.

Commonly, individual's that travel to the place of business of a tax preparer can reach high levels of stress and/or anxiety over the amount money they may owe to the state and/or federal government. This can lead to the individual not focused on their taxes and possibly forgetful of key facts the tax professional should know as they review tax related documents, bookkeeping matters, and/or payroll. It could also lead to personal physical and/or mental conditions.

To aid such individuals deal with their stress, anxiety, etc., in an embodiment, massage services could be offered as part of the tax service with the intent to relax the individual prior to and/or while they are speaking with a tax professional. In additional and/or alternatively, other services that could lead to relaxation such as manicures', pedicures, facials, iv drips, etc. can be offered to individuals. Such services should not be limited to those disclosed herein.

In an embodiment, the services references above could be offered in a vehicle (e.g., van) or attachment thereto (e.g. mobile trailer) along with the tax related services. For example, the tax professional could arrive at an individual's home in a vehicle equipped with facilities and supplies to review and complete tax related matters and a massage table or massage chair or other health and wellness services, drinks, etc. Alternatively, the tax preparer could arrive with an enclosed trailer attached to a vehicle with all of the above included therein.

As an alternative, or in addition to providing mobile services, the tax preparer could provide consultation services and wellness services in view of the above remotely then return to their place of business for further analysis of tax related documents and/or to prepare tax returns, assess payroll and/or bookkeeping maters and then return the individual's remote location (e.g., their home) to review the analysis, tax return, etc. with the individual prior to filing tax returns, processing payroll or addressing bookkeeping matters, if desired.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A tax service, comprising:
a vehicle that is configured to include tax related devices and supplies.

2. A method of offering mobile tax and other business services, comprising:
consultation at a desired location;
obtaining necessary documentation at the location;
leaving the desired location with the documentation;
assessing the documentation; and
returning to the location with the documentation.

3. A method of providing tax advice, comprising:
providing a vehicle that is configured to include tax related devices and supplies;
speaking to an individual about tax matters in the vehicle; and
analyzing tax related documents and providing advice thereon.
